(19) United States
(12) Patent Application Publication
(10) Pub. No.: US 2006/0238552 A1
(43) Pub. Date: Oct. 26, 2006

(54) Drive method to reduce power dissipation for flat panel display and device of the same

(76) Inventors: Yu-Chun Chuang, Hsinchu (TW); Wan-I Shih, Hsinchu (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/285,041

(22) Filed: Nov. 23, 2005

(30) Foreign Application Priority Data
Apr. 22, 2005 (TW) 094112840

(51) Int. Cl. G09G 5/10

(52) U.S. Cl. 345/690

(57) ABSTRACT

A control module for reducing power dissipation is connected to a column driving unit and a row driving unit. The control module includes a memory for storing display data temporarily and an arithmetic/logic unit connected to the memory. The arithmetic/logic unit takes grayscale image data of a current conducted row as a base row to compare with the grayscale image data of n rows that are temporarily stored in the memory and waiting to be scanned, so as to select the row with a minimum gray level difference as a next conducted row.

### BACKGROUND OF THE INVENTION

1. Field of the Invention

The invention relates in general to a scan method for a flat panel display drive device, and more particularly to a scan method that determines a scanning sequence according to a gray level difference of image data to reduce power dissipation.

2. Description of the Related Art

Referring to FIG. 2, a driving circuit for a conventional flat panel display is shown. A column driving unit 62 and a row driving unit 64 work together to control a flat panel 50 in general. The column driving unit 62 and the row driving unit 64 connects to a plurality of data lines 63 and scan lines 65, respectively. Multiple pixels 51 are formed on the flat panel 50. Each pixel 51 is mapping to a cross-position formed by the data lines 63 and the scan lines 65.

When controlling the flat panel 50 to output an image, the row driving unit 64 sequentially outputs scan signals to the scan lines 65. Each pixel 51 on the same row is determined to be charged or discharged according to a grayscale signal outputted by its own data line 63. A scan update speed is very prompt; hence static image quality of the output image can be displayed on the flat panel 50 due to ‘retention of image’ phenomenon experienced in human vision.

Consumer demand for increasingly higher resolution flat panel displays has resulted in the quantity of pixels on flat panels accordingly rising. Hence less time is distributed to conduct each scan line 65 while an update frequency on the image is unchanging. Therefore it is difficult for each pixel 51 to be fully charged/discharged within a very short time, thereby impairing the image quality and greatly decreasing a contrast degree on the image.

Moreover, a power dissipation problem is also a critical issue of the flat panel 50. The conventional row driving unit 64 as foresaid outputs the scan signals to the scan line 65 from the top to the bottom in sequence. Hence the power dissipation problem is manifest due to extremely charged/discharged operations when a huge grayscale variation exists between the pixels 51 of the two adjacent scan lines 65.

The flat panel is applied in various compact and portable electronic devices such as cell phones, PDAs, digital MP3 players, and so on. If the power dissipation of the flat panel can be effectively reduced, the entire power consumption of the electronic device can be accordingly improved.

### SUMMARY OF THE INVENTION

In view of the drawback of the conventional drive method for the flat panel device that higher power dissipation is generated due to a huge grayscale signal variation, it is accordingly an object of the present invention to provide a scan method that determines a scanning sequence according to a grayscale difference of image data to reduce power dissipation.

To achieve the above-mentioned objective, the present invention makes use of a drive device to control a panel that is formed with a plurality of pixels. The drive device mainly includes a column driving unit, a row driving unit, and a control module.

The column driving unit outputs a plurality of data lines to the panel. The row driving unit outputs a plurality of scan lines to the panel. The scan lines and the data lines contribute together to control the pixels on the panel. The control module is connected to the column driving unit and the row driving unit. The control module includes a memory for storing display data temporarily and an arithmetic/logic unit connected to the memory. The arithmetic/logic unit takes grayscale image data of a current conducted row as a base row to compare with the grayscale image data of n rows that are temporarily stored in the memory and waiting to be scanned, so as to select the row with a minimum gray level difference as a next conducted row.

The grayscale image data of the base row is compared with the grayscale image data of other rows which wait to be displayed one by one to calculate the gray level difference, and to select the row with the minimum gray level difference as the next conducted row until all of the m rows of the scan lines finish a complete scan update cycle.

Therefore, the power dissipation can be efficiently reduced with the method to compare the gray level difference of the image data to find an optimal scanning sequence.

### BRIEF DESCRIPTION OF THE DRAWING

FIG. 1 shows a circuit block diagram of the present invention.

FIG. 2 shows a diagram of a conventional drive method of a flat panel display.

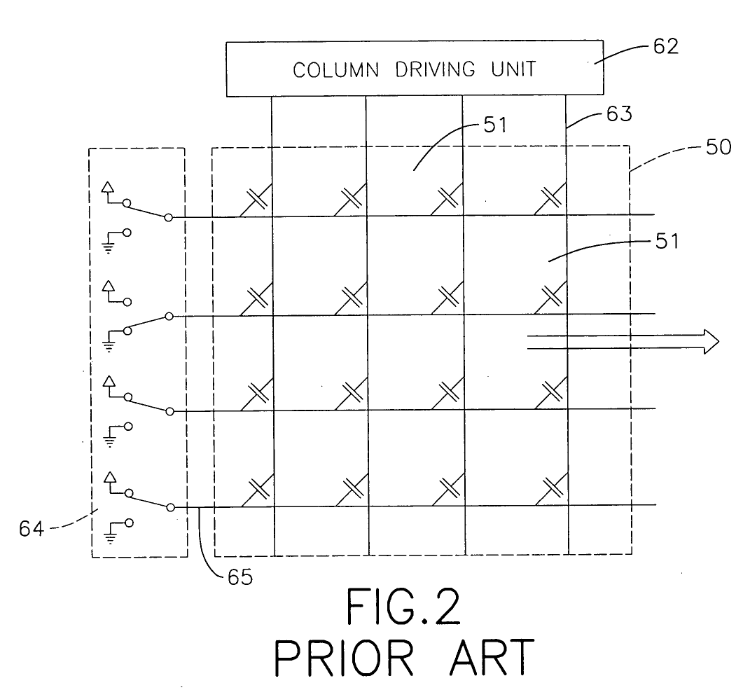

### DETAILED DESCRIPTION OF THE INVENTION

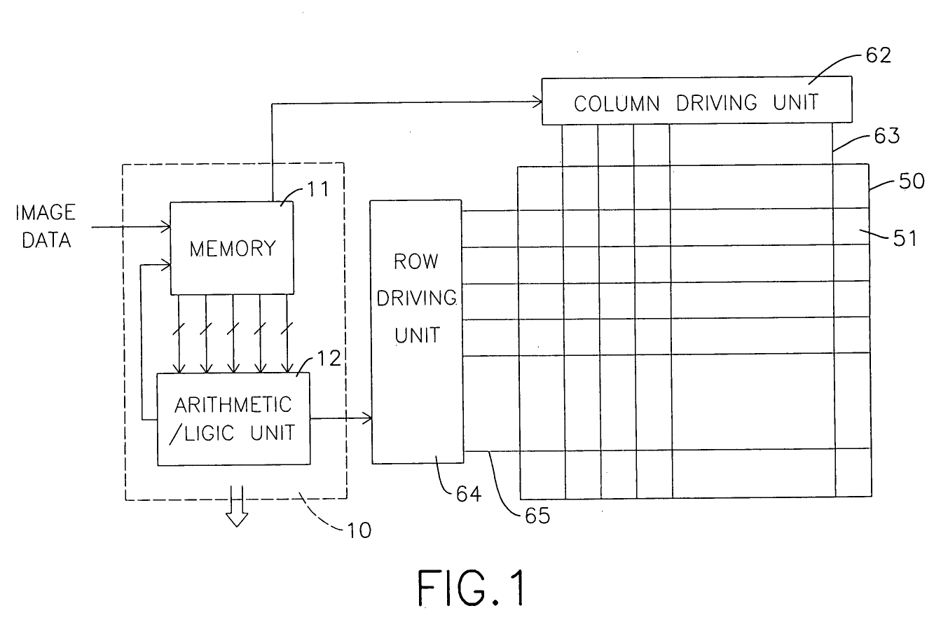

Referring to FIG. 1, a circuit block diagram of the present invention is shown. A flat panel 50 is controlled by a column driving unit 62 and a row driving unit 64 as aforesaid prior art. A plurality of scan lines 65 output by the row driving unit 64 and a plurality of data lines 63 output by the column driving unit 62 contribute together to control a plurality of pixels 51 arranged in a matrix on the panel. Moreover, a control module 10 determines a scanning sequence. The control module 10 includes a memory 11 for storing display data temporarily and an arithmetic/logic unit 12 connected to the memory 11.

According to the aforesaid prior art technique, the higher power dissipation is generated due to the huge grayscale variation of the two adjacent rows. Hence, if the grayscale variation between the two conducted rows can be diminished, the power dissipation can be effectively reduced. In terms of the above objective, a method of the present invention is provided as follows.

First of all, image data that waits to be displayed is stored temporarily in the memory 11. Then the temporarily stored image data is read from the memory 11 and outputted to the arithmetic/logic unit 12. A grayscale value of the scanning image data of a row is compared with other grayscale values of the image data that is waiting to be scanned one by one to compute a gray level difference between two rows. The row with the minimum gray level difference of the image data is selected as the next scanning row. The above step is repeated until all rows of the image data are all displayed.

To specifically explain the above method, several examples of the preferred embodiments of the present invention are provided as follows.

Firstly,

$${GLD}_{( ij )} = {\sum }_{k = 1}^{n} \vert {D}_{ik} - {D}_{jk} \vert$$

represents the gray level difference between two different rows of Rowᵢ and Rowⱼ where D represents the gray level value of each pixel point which is expressed by m bits (2^{m}) in general. Supposing that there are n pixels in one row, the gray level difference values of the two different rows (i,j) for a corresponding pixel point respectively is |Dᵢₖ−Dⱼₖ|. Thus a sum of the gray level difference values of the pixel points represents the GLD₍ᵢⱼ₎ of the two different rows Rowᵢ and Rowⱼ. To simplify the calculation, although the m bits (2^{m}) express the gray level of each pixel point, the most significant bit (MSB) having more obvious gray level value is taken for the calculation and the less significant bit (LSB) is neglected in an actual computation. For example, while computing a₅ a₄ a₃ a₂ a₁ a₀-b₅ b₄ b₃ b₂ b₁ b₀, a₁ a₀ and b₁ b₀ bits can be neglected and only the front four bits a₅ a₄ a₃ a₂ and b₅ b₄ b₃ b₂ are taken for comparison.

### Example Method A

Assume that the first row is the current conducted row. The GLD₍₂₁₎, GLD₍₃₁₎, GLD₍ₛ₁₎ for the gray level difference between the first row and the second row until the sth row are computed respectively by using the arithmetic/logic unit 12, so as to select the minimum gray level difference value. If the GLD₍₃₁₎ is minimum, the third row is thus selected as the next conducted row. Then the second, the fourth until the sth rows are compared with the third row to get the values of GLD₍₂₃₎, GLD₍₄₃₎, . . . GLD₍ₛ₃₎ to select the minimum gray level difference value again. In this way, the next conducted row is determined again. Hence this method is achieved by repeating the above step until all rows of the scan lines finish a complete scan update cycle.

### Example Method B

This method is to make the arithmetic/logic unit 12 compare the image data of the current conducted row with the image data of the rest N rows (at least two rows). The next conducted row is then determined by selecting the minimum gray level difference. Those unselected image data are still temporarily stored in the memory 11.

Base on the selected conducted row to compare with the image data temporary stored in the memory 11, the next conducted row having the minimum gray level difference value is then determined. Hence this method is achieved by repeating the above step until all rows of the scan lines finish a complete scan update cycle.

Take two rows as an example (N=2). If the current conducted row is the first row, the second and the third rows are compared with the first row respectively to get GLD₍₂₁₎ and GLD₍₃₁₎. If GLD₍₃₁₎<GLD₍₂₁₎, the third row is selected as the next conducted row. Simultaneously, the data image of the second row is still temporarily stored in the memory 1. Then the image data of the fourth row is fetched and read to calculate the gray level difference value of GLD₍₂₃₎ and GLD₍₄₃₎ and so forth.

However, in the above-described two methods A and B, special case will take place when the gray level difference is too large between the conducted row and the specific ones, which results in the scanning speed of such row become extremely low. If the scanning speed is lower than the sufficient frame rate, human eyes are likely detecting the flicker of the frame. In order to avoid the aforesaid situation that impairs the image display quality, the control module 10 includes a function to force such scan lines to be scanned and updated in a specific time. Even though the gray level difference value of the particular row does not meet a requirement, the particular row is still forced to be conducted to scan, so as to provide an optimum image output.

### Example Method C

This method is based on grouping a constant quantity of rows to get the most efficient sequence to conduct the data rows. For example, if four rows are grouped as Row₁, Row₂, Row₃, and Row₄ where the current conducted row is the Row₁, then the following values are computed:
SGLD_{(1→2→3→4)}=GLD₍₂₁₎+GLD₍₃₂₎+GLD₍₄₃₎
SGLD_{(1→2→4→3)}=GLD₍₂₁₎+GLD₍₄₂₎+GLD₍₃₄₎
SGLD_{(1→3→2→4)}=GLD₍₃₁₎+GLD₍₂₃₎+GLD₍₄₂₎
SGLD_{(1→3→4→2)}=GLD₍₃₁₎+GLD₍₄₃₎+GLD₍₂₄₎
SGLD_{(1→4→2→3)}=GLD₍₄₁₎+GLD₍₂₄₎+GLD₍₃₂₎
SGLD_{(1→4→3→2)}=GLD₍₄₁₎+GLD₍₃₄₎+GLD₍₂₃₎

The above six SGLD values indicate all possible permutations for the sum of the gray level difference values of the four rows. The minimum SGLD value represents the optimum sequence to conduct the scan lines. When the sequence for the Row₁ to Row₄ is determined, the most recent conducted row is set as the base row to compare with Row₅, Row₆, and Row₇. Thereby the optimum sequence for Row₅ to Row₇ can be determined. In this way, N rows of data are grouped to be computed until all rows on the panel are computed. This method can avoid the aforesaid situation that the particular row is unable to be conducted to scan in the above-described two methods A and B, thereby impairing the image display quality.

In view of the drawback of the conventional drive method having higher power dissipation due to the simple scanning sequence line by line, it is accordingly the object of the present invention to provide the scan method that determines the scanning sequence according to the gray level difference of the image data to reduce power dissipation. Therefore, the present invention greatly improves the conventional drive method.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A driving method for reducing power dissipation for a flat panel display, wherein the flat panel display comprising m rows of scan lines, the method comprising the steps of:
setting grayscale image data of a current conducted row as a base row; and
comparing the grayscale image data of the base row with the grayscale image data of n rows which wait to be scanned so as to select a row with a minimum gray level difference as a next conducted row.

2. The method as claimed in claim 1, wherein the grayscale image data of the base row is sequentially compared with the grayscale image data of all m rows that wait to be displayed one by one to calculate the gray level differences, and to select the row with the minimum gray level difference as the next conducted row until all of the m rows of the scan lines finish a complete scan update cycle.

3. The method as claimed in claim 1, wherein the grayscale image data of the base row is compared with the grayscale image data of a part of the rows which wait to be scanned to select the row with the minimum gray level difference as the next conducted row, and repeat in the same method until all of the m rows of the scan lines finish a complete scan update cycle.

4. The method as claimed in claim 2, wherein the unselected scan lines which wait to be scanned can be forced to be conducted to scan.

5. The method as claimed in claim 3, wherein the unselected scan lines which wait to be scanned can be forced to be conducted to scan.

6. A driving method for reducing power dissipation for a flat panel display, wherein the flat panel display comprising m rows of scan lines, the method comprising the steps of:
defining N rows of scan lines as a current group, wherein the scan line that is the last conducted in a previous group is set as a baseline in the current group;
calculating (N+1)! types of sums of the gray level difference for the current group of the N rows of the scan lines that wait to be judged;
selecting a type with the minimum sum of the gray level difference to determine a conducted sequence of the group of the scan lines.

7. A driving device for reducing power dissipation for a flat panel display with a panel that is formed with a plurality of pixels, wherein the driving device comprises:
a column driving unit that outputs multiple data lines to the panel;
a row driving unit that outputs multiple scan lines to the panel, wherein the scan lines and the data lines contribute together to control the pixels on the panel; and
a control module connecting to the column driving unit and the row driving unit, wherein the control module comprises a memory for storing display data temporarily and an arithmetic/logic unit connected to the memory, wherein the arithmetic/logic unit takes grayscale image data of a current conducted row as a base row to compare with the grayscale image data of n rows that are temporarily stored in the memory and wait to be scanned, so as to select the row with a minimum gray level difference as a next conducted row.
